(19) United States
(12) Patent Application Publication
(10) Pub. No.: US 2011/0292798 A1
(43) Pub. Date: Dec. 1, 2011

(54) SELECTIVELY PROVISIONING CALL SETUP QUALITY OF SERVICE (QoS) RESOURCE RESERVATIONS DURING A COMMUNICATION SESSION WITHIN A WIRELESS COMMUNICATIONS SYSTEM

(75) Inventor: Vivek MANPURIA, San Diego, CA (US)

(73) Assignee: QUALCOMM Incorporated, San Diego, CA (US)

(21) Appl. No.: 13/105,685

(22) Filed: May 11, 2011

Related U.S. Application Data
(60) Provisional application No. 61/349,339, filed on May 28, 2010.

(51) Int. Cl. H04W 28/26

(52) U.S. Cl. 370/231

(57) ABSTRACT

A dormant AT receives a request to initiate a communication session with at least one target AT. At this point, the AT does not have an active TCH associated or a QoS reservation at least for an IP flow associated with call setup for the communication session to be initiated. The AT configures and transmits, to an access network (AN), a message at least to request the QoS resource reservation for the IP flow associated with call setup for the communication session to be initiated. The AN grants the request for the QoS resource reservations for the IP flow. In an embodiment, the AN can grant the QoS resource request by transmitting a QoS resource reservation assignment message on an assigned TCH to the AT. A target AT of the session is also allocated an active TCH and IP-flow QoS resource reservation by the AN.

### CLAIM OF PRIORITY UNDER 35 U.S.C. §119

The present application for patent claims priority to Provisional Application No. 61/349,339 entitled “SELECTIVELY PROVISIONING CALL SETUP QUALITY OF SERVICE (QoS) RESOURCE RESERVATIONS DURING A COMMUNICATION SESSION WITHIN A WIRELESS COMMUNICATIONS SYSTEM” filed May 28, 2010 and assigned to the assignee hereof and hereby expressly incorporated by reference herein in its entirety.

### BACKGROUND OF THE INVENTION

1. Field of the Invention

The invention relates to communications in a wireless telecommunication system and more particularly to selectively provisioning call setup Quality of Service (QoS) resource reservations during a communication session within a wireless communications system.

2. Background

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communications network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1x-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3rd Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

A dormant AT receives a request to initiate a communication session with at least one target AT. At this point, the AT does not have an active TCH associated or a QoS reservation at least for an IP flow associated with call setup for the communication session to be initiated. The AT configures and transmits, to an access network (AN), a message at least to request the QoS resource reservation for the IP flow associated with call setup for the communication session to be initiated. The AN grants the request for the QoS resource reservations for the IP flow. In an embodiment, the AN can grant the QoS resource request by transmitting a QoS resource reservation assignment message on an assigned TCH to the AT. A target AT of the session is also allocated an active TCH and IP-flow QoS resource reservation by the AN.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1A is a diagram of a wireless network architecture that supports access terminals and access networks in accordance with at least one embodiment of the invention.

FIG. 1B illustrates the carrier network according to an example embodiment of the present invention.

FIG. 2 is an illustration of an access terminal in accordance with at least one embodiment of the invention.

FIGS. 3A-3C are signal flow diagrams in accordance with embodiments of the invention.

FIG. 4 is an illustration of a group communication system in accordance with at least one embodiment of the invention.

FIG. 5 is an illustration of Radio Link Protocol (RLP) flows in accordance with at least one embodiment of the invention.

FIG. 6 is a flowchart in accordance with at least one embodiment of the invention.

FIG. 7 is a signal flow diagram related to a target access terminal in accordance with at least one embodiment of the invention.

FIGS. 8A and 8B illustrate a conventional call setup process for a server-arbitrated communication session.

FIGS. 9A and 9B illustrate a call setup process for a server-arbitrated communication session in accordance with at least one embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station (e.g. a 1xEV-DO enabled wireless device), referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or mobile switching center (MSC). Modem pool transceivers and modem pool controllers are parts of a network called an access network. An access network (AN) (also referred to herein as a radio access network (RAN)) transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

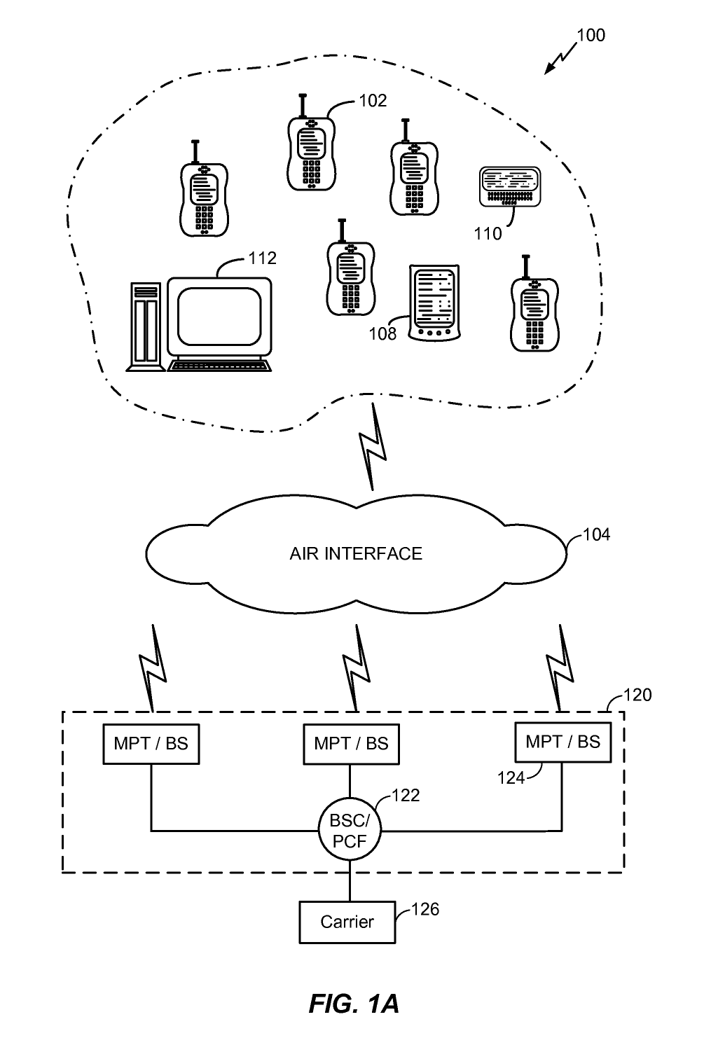

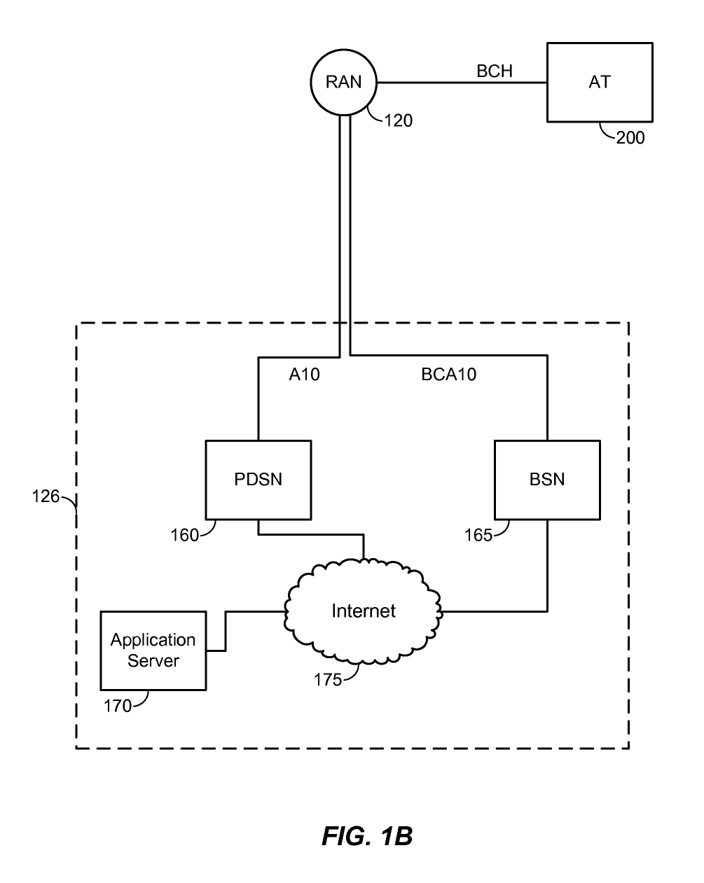

FIG. 1A illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1A, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 160 (“PDSN”) (e.g., shown in FIG. 1B) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

FIG. 1B illustrates the carrier network 126 according to an embodiment of the present invention. In the embodiment of FIG. 1B, the carrier network 126 includes a packet data serving node (PDSN) 160, a broadcast serving node (BSN) 165, an application server 170 and an Internet 175. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1A) utilizing, for example, a cdma2000 Radio Access Network (RAN) (e.g., RAN 120 of FIG. 1A). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 1B, the PDSN 160 may communicate with the RAN 120 (e.g., the BSC/PCF 122) via a conventional A10 connection. The A10 connection is well-known in the art and will not be described further for the sake of brevity.

Referring to FIG. 1B, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

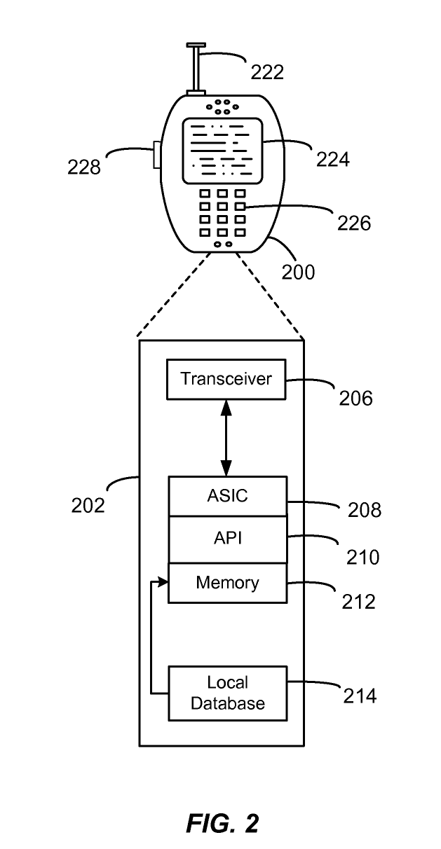

Referring to FIG. 2, the access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API”) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. For example, the access terminal can include logic configured to bundle a connection request and a reservation for QoS resources into an access message and logic configured to transmit the access message to an access network. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 2 are to be considered merely illustrative and the invention is not limited to the illustrated features or arrangement.

The wireless communication between the access terminal 102 and the RAN 120 can be based on different technologies, such as code division multiple access (CDMA), time division multiple access (TDMA), frequency division multiple access (FDMA), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the access network using a variety of networks and configurations. Accordingly, the illustrations provided herein are not intended to limit the embodiments of the invention and are merely to aid in the description of aspects of embodiments of the invention.

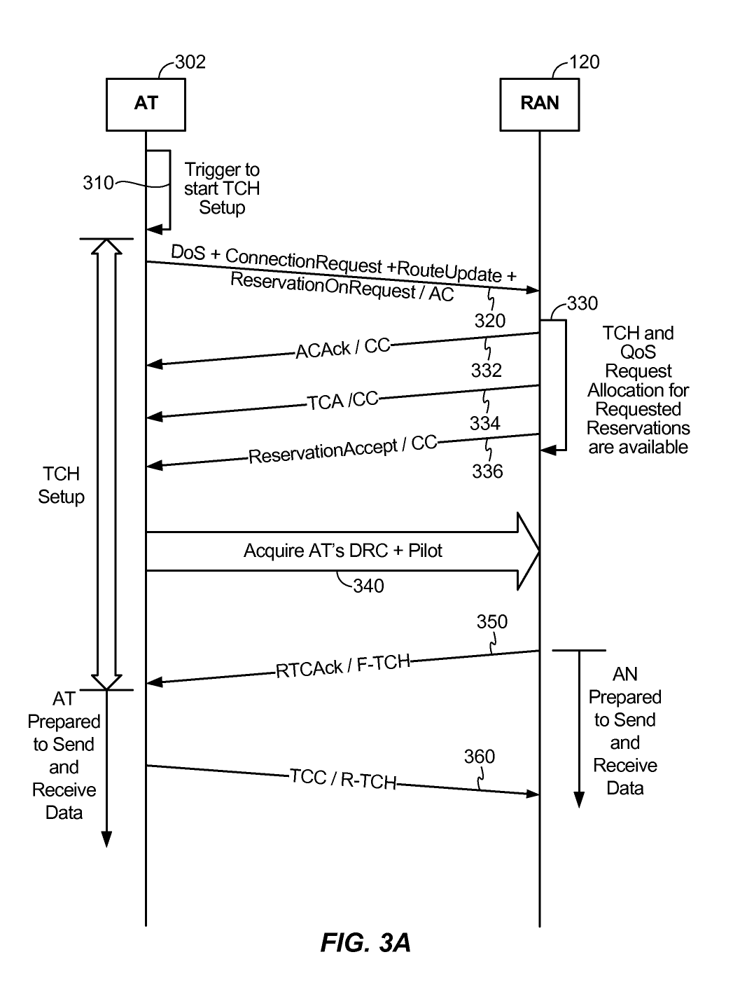

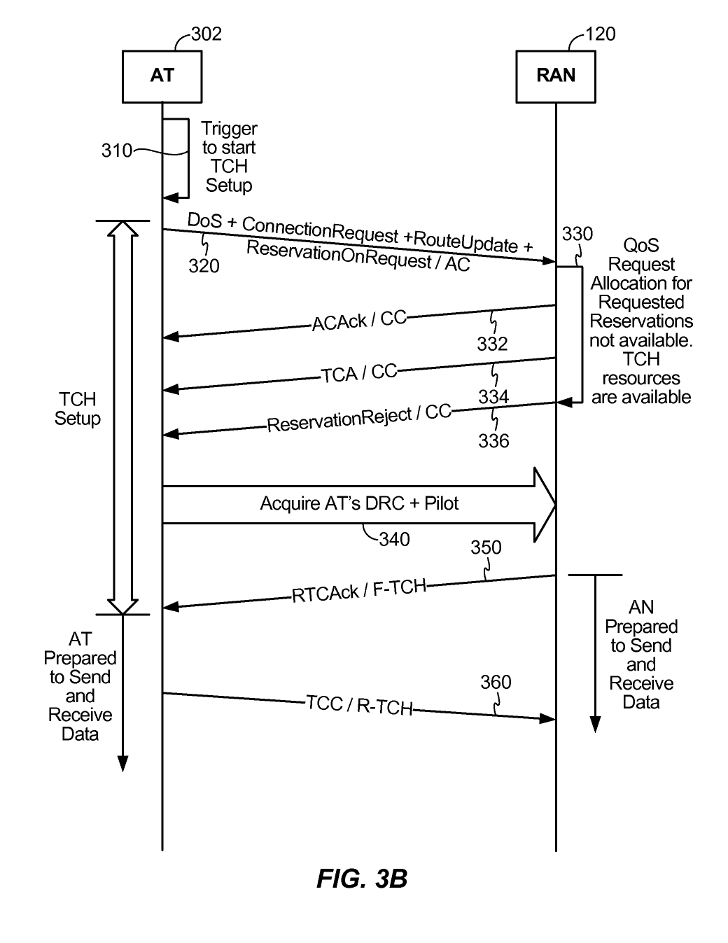

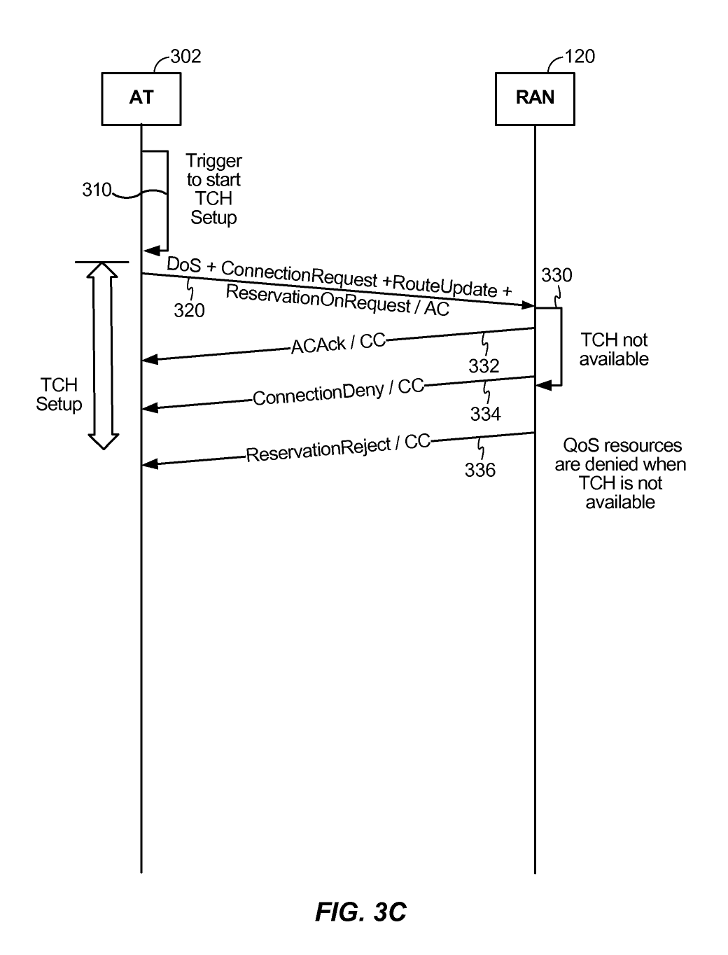

FIG. 3A illustrates a flow diagram for bundling communications in accordance with embodiments of the invention. In 310, there is an initial trigger at an access terminal (AT) 302 to establish the communication request (e.g., a PTT button 228 is pressed) and the information needed to establish the communication with the radio access network (RAN) 120 is bundled into an access channel message (e.g., a connection request (ConnectionRequest) and route update information (RouteUpdate)), provisioning for any QoS services used for the communication (ReservationOnRequest), etc.). Additionally, application layer data (e.g. a DataOverSignaling (DOS) message) may also be bundled in the access channel message to expedite communication with an end application (e.g., the group server, application resident on another AT, etc.) Once the access message is bundled with the desired information (e.g., DOS+ConnectionRequest+RouteUpdate+ReservationOnRequest), the access message can be sent 320 over the access channel (AC) to the radio access network (RAN) 120.

Once the bundled message 320 is received at the access network 120, the access network can process the request 330. In 330, the access network can allocate a traffic channel (TCH) and the requested QoS resources for the requested reservations, assuming the traffic channel and QoS resources are available. Specifically, the access network 120 can acknowledge the access message (ACAck), 332, transmit a traffic channel assignment (TCA), 334, and transmit a reservation accept message (ReservationAccept), 336. These messages can be transmitted on a control channel (CC) to AT 302. A data rate control (DRC) message can be sent, 340, from the AT 302 to establish a data communication rate with the RAN 120. After successfully receiving and decoding the DRC and pilot, the RAN 120 can transmit a Reverse Traffic Channel Acknowledge (RTCAck) message, 350, on the forward traffic channel (F-TCH). Upon receipt of the RTCAck message, the AT 302 can send a Traffic Channel Complete (TCC) message, 360, on the reverse traffic channel (R-TCH). Dedicated channels are then established in both the forward and reverse directions and the AT 302 and the RAN 120 can both communicate data bidirectionally. The various messages communicated between access terminal 302 and access network 120 are known in the art and are documented in 3GPP2 C.S0024-A Version 3.0, cdma2000 High Rate Packet Data Air Interface, dated Sep. 12, 2006, which is incorporated herein by reference in its entirety. Accordingly, a detailed explanation of the setup procedures and messages will not be provided herein.

If the DOS message or other application layer message is optionally bundled in the connection request access message, that information does not impact the traffic channel setup, discussed in the foregoing. Generally, the application specific data can be detected and merely passed on to the appropriate destination by RAN 120. However, the application specific information may further reduce latency in delay sensitive applications by providing data needed (e.g., a PTT call request) for further processing by remote applications (e.g., a PTT server) to establish the data communication (e.g., a PTT call) once the traffic channels are setup between AT 302 and RAN 120. Accordingly, the data included in the application layer message does not have to wait for the establishment of the traffic channels between the AT 302 and RAN 120 before being forwarded to the network.

As will be appreciated by those skilled in the art the QoS resources needed may vary for different applications or within applications. The following examples describe QoS design under different QoS resource scenarios:
When traffic channel resources and QoS resources (e.g., In-Call Signaling and Media reservations) are available in the sector of the originator AT 302 sector, the RAN signals that QoS resources are available for both the forward and reverse links by transmitting FwdReservationOn and RevReservationOn messages for the In-Call Signaling and Media reservations. This case is illustrated in FIG. 3A and described in the foregoing description.
When traffic channel resources are available in the sector where the originator AT 302 is located, but QoS resources for some or all of the reservations are not available, the RAN 120 can still allocate the traffic channel and transmits the TCA message to the originator AT 302. However, the RAN 120 rejects the QoS request for the reservations it cannot provision by transmitting a ReservationReject message to AT 302. The availability of the traffic channel enables the AT 302 to attempt to complete its call setup signaling handshake over the traffic channel when the QoS resources (e.g., In-Call Signaling and Media reservations) are not available. This case is illustrated in FIG. 3B.
When no traffic channel resources are available in the originator AT's sector, the AN denies the traffic channel request by transmitting the ConnectionDeny message (e.g., per the 1xEV-DO Revision A standard). In this case the QoS request for the reservations also is denied by transmitting a ReservationReject message to AT 302. This case is illustrated in FIG. 3C.

If some of the In-Call Signaling and Media reservations are already allocated to the originator AT at the time of arrival of a call setup packet, the AN/RAN may only activate the In-Call Signaling and Media reservations that are not currently allocated.

As noted above, embodiments of the invention can reduce process delays in delay sensitive applications. A group communication/Push-to-Talk (PTT) system is an example of a delay sensitive system that can take advantage of reduced connection times offered by the communication signal bundling disclosed herein. For example, embodiments of the invention provide for an AT to send a request to turn on the reservations for needed QoS resources (e.g., In-Call Signaling and Media reservations for a PTT call) by transmitting a ReservationOnRequest message in the same access capsule as its connection request (e.g., ConnectionRequest+RouteUpdate) message. Optionally, a DataOverSignaling (DOS) message can be bundled in the same access capsule. If the In-Call Signaling forward and reverse QoS reservations are allocated at the time of the PTT call, the AT can request the Media QoS reservations to be turned on. These requests can be made as part of the ReservationOnRequest message.

The group communication system may also be known as a push-to-talk (PTT) system, a net broadcast service (NBS), a dispatch system, or a point-to-multi-point communication system. Typically, a group of access terminal users can communicate with one another using an access terminal assigned to each group member. The term “group member” denotes a group of access terminal users authorized to communicate with each other. Although, group communication systems/PTT systems may be considered to be among several members, the system is not limited to this configuration and can apply to communication between individual devices on a one to one basis.

The group may operate over an existing communication system, without requiring substantial changes to the existing infrastructure. Thus, a controller and users may operate in any system capable of transmitting and receiving packet information using Internet protocol (IP), such as a Code Division Multiple Access (CDMA) system, a Time Division Multiple Access (TDMA) system, a Global System for Mobile Communications (GSM) system, satellite communication systems, combinations of land line and wireless systems, and the like.

Group members may communicate with each other using an assigned access terminal, such as access terminals (ATs) 102, 108, and 302. The ATs may be wireline or wireless devices such as terrestrial wireless telephones, wireline telephones having push-to-talk capability, satellite telephones equipped with push-to-talk functionality, laptop or desktop computers, paging devices, or any combination thereof. Furthermore, each AT may be able to send and receive information in either a secure mode, or a non-secure (clear) mode. It should be understood that reference to an AT is not intended to be limited to the illustrated or enumerated examples, and may encompass other devices that have the capability to transmit and receive packet information in accordance with the Internet Protocol (IP).

When a group member wishes to transmit information to other members of the group, the member may request the transmission privilege by pressing a push-to-talk button or key (e.g., 228 in FIG. 2) on an AT, which generates a request formatted for transmission over a distributed network. For example, the request may be transmitted over the air to one from AT 102 or more MPTs (or base stations) 124. A BSC/PCF122, which may include a well-known inter-working function (IWF), packet data serving node (PDSN), or packet control function (PCF), for processing data packets may exist between MPT/BS 124 and the distributed network. However, the requests may also be transmitted through the public switched telephone network (PSTN) to a carrier network 126. The carrier network 126 may receive the request and provide it to the RAN 120.

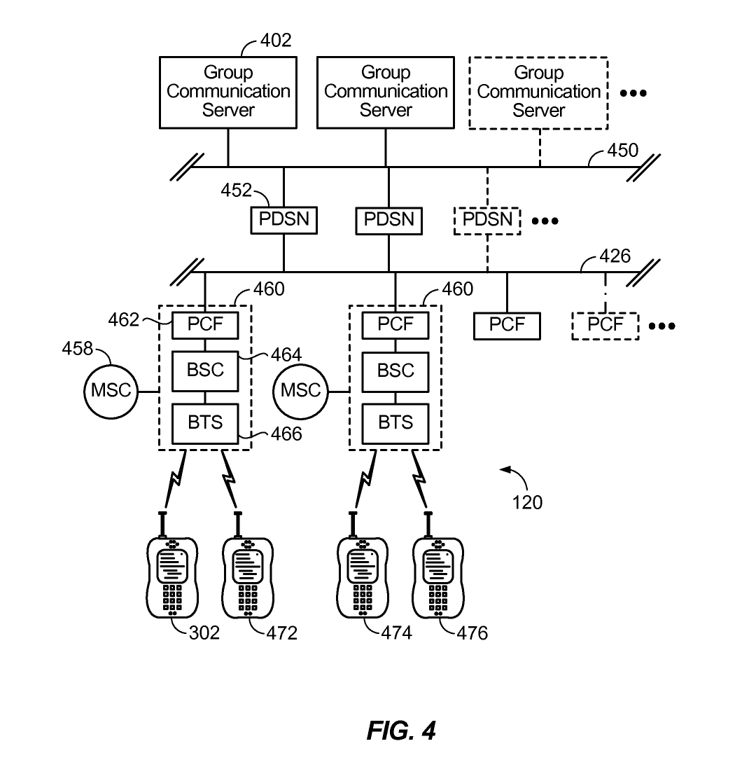

Referring to FIG. 4, one or more group communication servers 402 can monitor traffic of the group communication system through its connection to distributed network. Since the group communication server 402 can be connected to the distributed network through a variety of wired and wireless interfaces, geographic proximity to group participants is not necessary. Typically, a group communication server 402 controls communications between the wireless devices of set group members (ATs 302, 472, 474, 476) in a PTT system. The wireless network illustrated is merely exemplary and can include any system whereby remote modules communicate over-the-air between and among each other and/or between and among components of a wireless network including, without limitation, wireless network carriers and/or servers. Further, a series of group communication servers 402 can be connected to a group communication server LAN 450.

The group communication server(s) 402 can be connected to a wireless service provider's packet data service node (PDSN) such as PDSN 452, shown here resident on a carrier network 426. Each PDSN 452 can interface with a base station controller 464 of a base station 460 through a packet control function (PCF) 462. The PCF 462 may be located in the base station 460. The carrier network 426 controls messages (generally in the form of data packets) sent to a MSC 458. The MSC 458 can be connected to one or more base stations 460. In a similar manner to the carrier network, the MSC 458 is typically connected to the BTS 466 by both the network and/or Internet for data transfer and PSTN for voice information. The BTS 466 ultimately broadcasts and receives messages wirelessly to and from the wireless ATs, such as cellular telephones 302, 472, 474, 476, as is well known in the art. Accordingly, the general details of a group communication system will not be further discussed. Further, although the description herein discusses specific aspects of specific systems (e.g., PTT, QChat®, 1xEV-DO) to provide additional details and examples, embodiments of the invention are not limited to these specific illustrations.

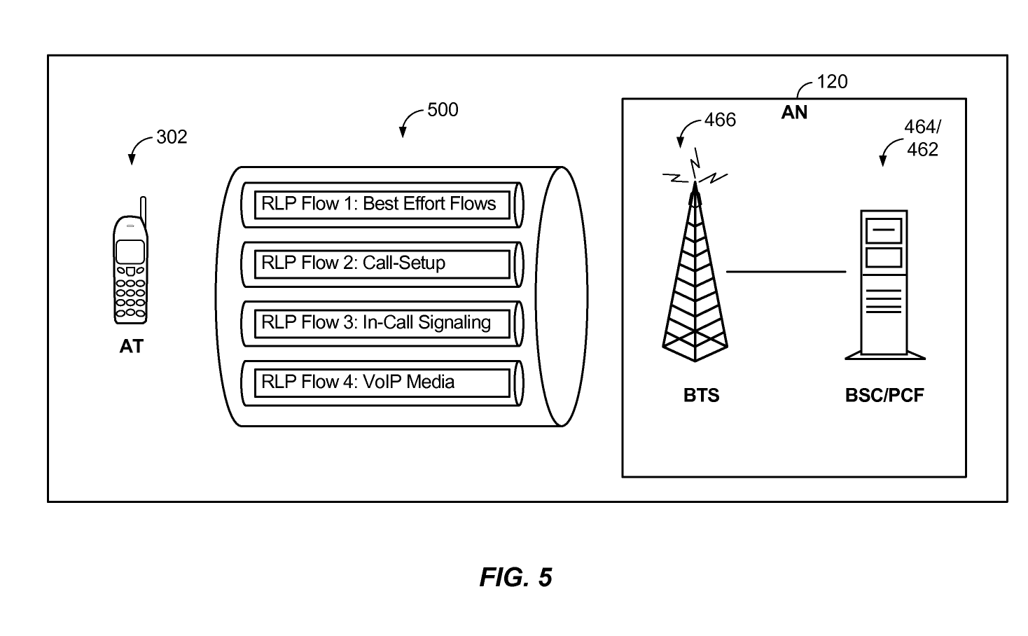

As discussed above, the AT 302 requests a traffic channel in order to establish a communication (e.g., a PTT call). The PTT call can be originated by the originator AT 302 if both, traffic channel and QoS resources for In-Call Signaling and Media are available (additional details regarding the QoS resources are provided below and in FIG. 5). In the conventional systems, the AT 302 would have to establish the traffic channel connection with the RAN 120 and then request the QoS resources. However, to reduce this delay in accordance with embodiments of the invention, the signaling messages need to establish the PTT call are bundled in the initial access channel message along with the original connection request.

1xEV-DO Revision A is designed to provide efficient access to packet data networks and is widely based on the Internet for its network architecture. Data traffic traversing Internet Protocol (IP) network elements at the PDSN 452, PCF 462, and RAN 120 can be based on standard Internet Engineering Task Force (IETF)-based protocols that support methods for differentiating traffic based on QoS requirements. QoS between the AT 302 and the 1xEV-DO Revision A network is configured as described in the 3GPP2 X.S0011-004-C Version 2.0 cdma2000 Wireless IP Network Standard: Quality of Service and Header Reduction specification, the contents of which are incorporated herein by reference. Data traffic transmitted over the air interface between the AT 302 and the RAN 120 can be configured for appropriate QoS treatment via 1xEV-DO Revision A protocols as described in the 3GPP2 C.S0024-A Version 3.0 document referenced above. 1xEV-DO Revision A provides standard mechanisms to offer intra-AT and inter-AT QoS. Intra-AT QoS provides differentiation of data streams belonging to the same user, while inter-AT QoS provides differentiation of packets belonging to different users.

To achieve QoS, traffic differentiation should be available end-to-end. All network components including the AT 302, RAN 120 (BTS 466, BSC 464), PDSN 452, and Internet routers should implement/support QoS. End-to-end QoS in 1xEV-DO Revision A networks can be achieved through the following mechanisms:
Packet Fitters: Packet filters at the PDSN map forward traffic flows to the AT and define the QoS treatment that should be applied to forward data traffic. The AT signals QoS requests that establish packet filters at that PDSN as described in the 3GPP2 X.S0011-004-C Version 2.0 cdma2000 Wireless IP Network Standard: Quality of Service and Header Reduction specification.
QoS Profiles (Profile IDs): QoS Profiles and/or Profile IDs are a mechanism to specify (or predefine) relevant air interface parameters and network QoS requirements for a data service. It is a ‘shorthand’ identifier that the AT uses when requesting a QoS reservation for a flow with the RAN. Standard Profile ID assignments available for various data services are described in TSB58-G Administration of Parameter Value Assignments for cdma2000 Spread Spectrum Standards, the contents of which are incorporated herein by reference.
Reverse Traffic Marking: The AT can mark reverse traffic data in accordance with the Differentiated Services (DiffServ) framework and standards. These markings define the QoS network treatment requested for data outbound at the PDSN.

QoS in a 1xEV-DO Revision A network is also based on the proper mapping or binding of the following elements for the AT's PPP session, such as follows:
IP (Application) Flow: Application layer QoS requirements at the AT and PDSN are defined by identifying unique IP flows. A reservation label is associated with the IP flow to identify the QoS requirements for the flow between the AT and the RAN. An IP flow is then mapped onto an RLP flow that best satisfies the QoS requirements.
RLP (Link) Flow: Radio Link Protocol (RLP) flows are allocated based on QoS requirements (e.g., RLP parameter configuration) for upper layer flows. IP flows with the same QoS requirements can be mapped onto the same RLP flow. In the reverse direction, an RLP flow is mapped onto a (Reverse Traffic Channel Media Access Control) RTCMAC flow.
RTCMAC flow: RTCMAC flows are allocated based on QoS requirements that define physical layer latency and/or capacity needs for an upper layer flow. For example, flows can be low-latency or high capacity flows. RLP flows with the same QoS requirements can be mapped to the same RTCMAC flow.

FIG. 5 illustrates the multiple RLP flows 500 for a PTT-enabled AT 302 in communication with access network 120. The QoS requirements for each flow can be specified via QoS profiles. As noted above different applications can have different QoS requirements. For example, PTT over 1xEV-DO Revision A receives high priority and low latency data delivery through the specification of network QoS requirements. An exemplary PTT system can use the allocation of three IP flows at the AT, a flow for Call-Setup Signaling; a flow for In-Call Signaling; and a flow for Media. Each IP flow has specific QoS requirements and is mapped onto three separate RLP flows. The AT can further use a default Best Effort (BE) flow. QoS requirements for Media can be considered to be similar to VoIP media and therefore this RLP flow can be shared with VoIP.

Although the foregoing description provides many details specific to a PTT/QChat® system and the 1xEV-DO network to provide a detailed illustration of various aspects of embodiments of the invention, those skilled in the art will appreciate that embodiments of the invention are not limited to any specific application and/or network. Embodiments of the invention can include any application that has QoS requirements. Further, any network that can support the allocation of QoS resources bundled with the initial connection setup request can also be included in embodiments of the invention.

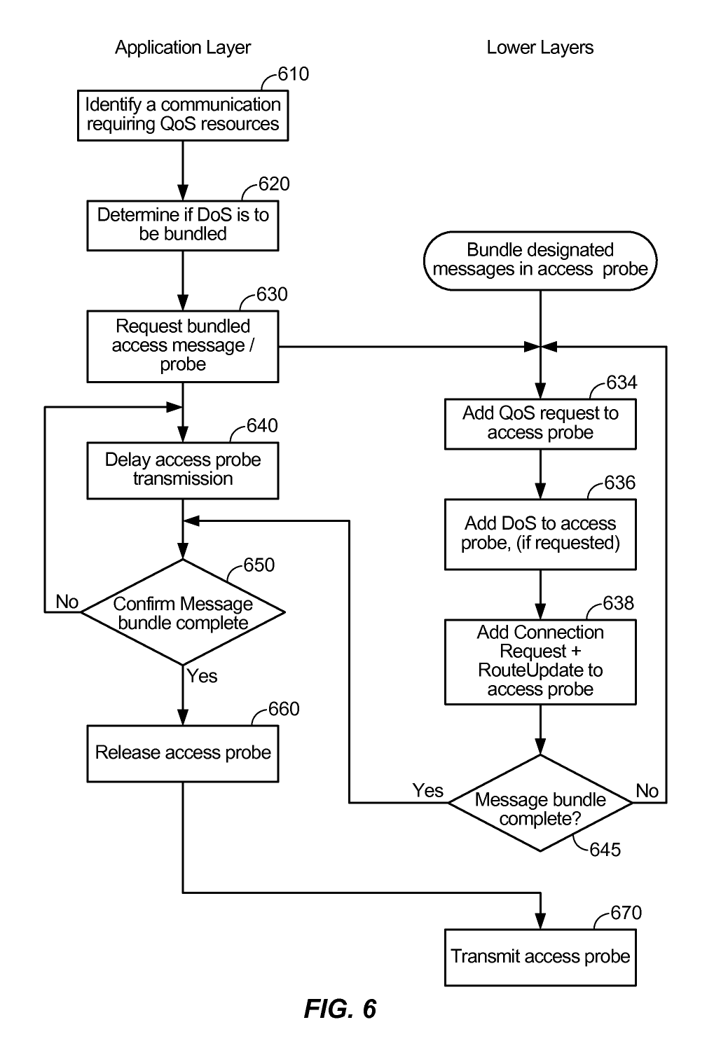

Referring to FIG. 6, a flowchart illustrating the bundling process according to embodiments of the invention is provided. For example, the method can include an application identifying a communication to be requested requires QoS resources (e.g., a PTT call), in block 610. Additional messages can be considered for bundling (e.g., DOS message) 620, if the additional message is used and there is room in the access probe. A request for a bundled access message (e.g., access probe) can then be communicated from the application layer, in block 630, to lower layers for bundling of the requested messages in the access probe. As used herein the application layer can include the requesting application (e.g., a PTT client) and a bundling API that facilitates interface between the application layer and the lower layers (e.g., RLC, MAC, and Physical Layers). However, it will be appreciated that embodiments of the invention are not limited to this configuration. For example, the application itself could contain the functionality of the bundling API.

In block 634, after the receipt of the bundled request, the QoS request can be added to the access probe. Likewise, in block 636, the DOS message can be added to the access probe if requested and there is sufficient space in the access probe. Additionally, in block 638, the connection request and route update messages are added to the access probe. A check can be performed to determine whether the bundled message is complete, in block 645. If not, the process can loop back to check for the missing messages, as they may be delayed. A delay element (e.g., timer) can also be set at the application layer, in block 640, to allow for the bundling of the access probe. The process can loop via block 650 until the application layer receives an indication from the lower layers that the message bundling is complete 645 (or until the event is timed out and the access probe is sent). After receiving the confirmation, the access probe delay can be released, 660, and the access probe can be transmitted 670.

As discussed in the foregoing, the trigger (e.g., 310) can be any event that causes an application to initiate a connection request with QoS requirements, which are known to the application. The trigger may be activated manually via hard key or soft key activation, may be activated in response to a received signal (e.g., voice command, signal from the network, etc.) or may be activated in response to condition detected by the application.

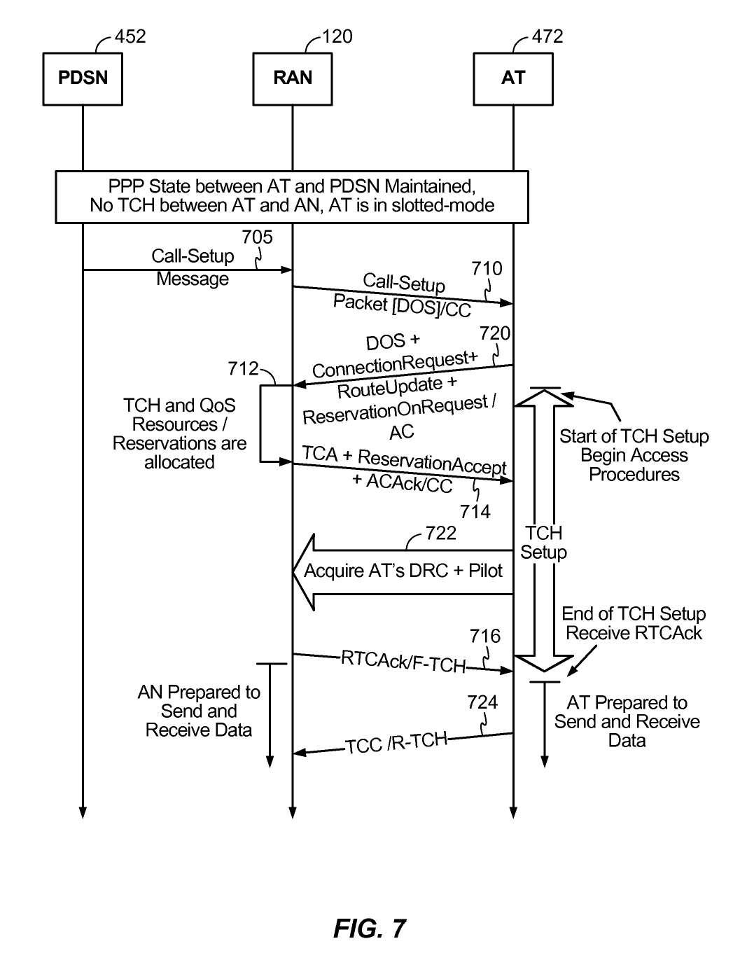

For example, as illustrated in FIG. 7, an access terminal (AT) 472, may receive a trigger, such as an announce message or call setup message, 705, in a PTT system. Specifically, a call setup message, 705, can be transmitted via PDSN 452 and RAN 120. Access network 120 can forward the call setup message over a control channel, 710, to the target AT 472. Upon receipt and decoding of the call setup packet, AT 472 can determine that the requested communication (e.g., a PTT call) uses QoS resources. Accordingly, the call setup message received from the network can serve as a trigger to initiate the bundling of the subsequent response.

For example, AT 472 can respond with a bundled request, 720, including a connection request (e.g., ConnectionRequest, +RouteUpdate), a QoS reservation (e.g., ReservationOnRequest) and optionally an application layer message (e.g., DOS) on an access channel. Including the DOS allows for application data to be sent to a destination prior to establishing a traffic channel. Requesting the QoS resources allows for the allocation of the need QoS resources prior to establishing the traffic channel. Accordingly, the responsiveness of the communication system may be improved. Upon receipt of the connection request a traffic channel and requested resources can be allocated, 712, at access network (AN) 120. The traffic channel assignment (TCA), QoS resources acceptance, and acknowledgement of the access channel message can be transmitted, 714, to AT 472. The traffic channel setup can continue in 722, 716 and 724, until both the RAN 120 and AT 472 are prepared to send and receive data as discussed in the foregoing and known in the art. Accordingly, a detailed explanation will not be provided.

In view of the foregoing disclosure, those skilled in the art will recognize that embodiments of the invention include methods of performing the sequence of actions, operations and/or functions previously discussed. For example, a method for transmitting communication signals in a wireless network can include bundling a connection request and a reservation for QoS resources into an access message at an access terminal, and transmitting the access message to an access network. The bundled message can further include an application layer message (e.g., DOS message) that is bundled with the connection request and the reservation into the access message.

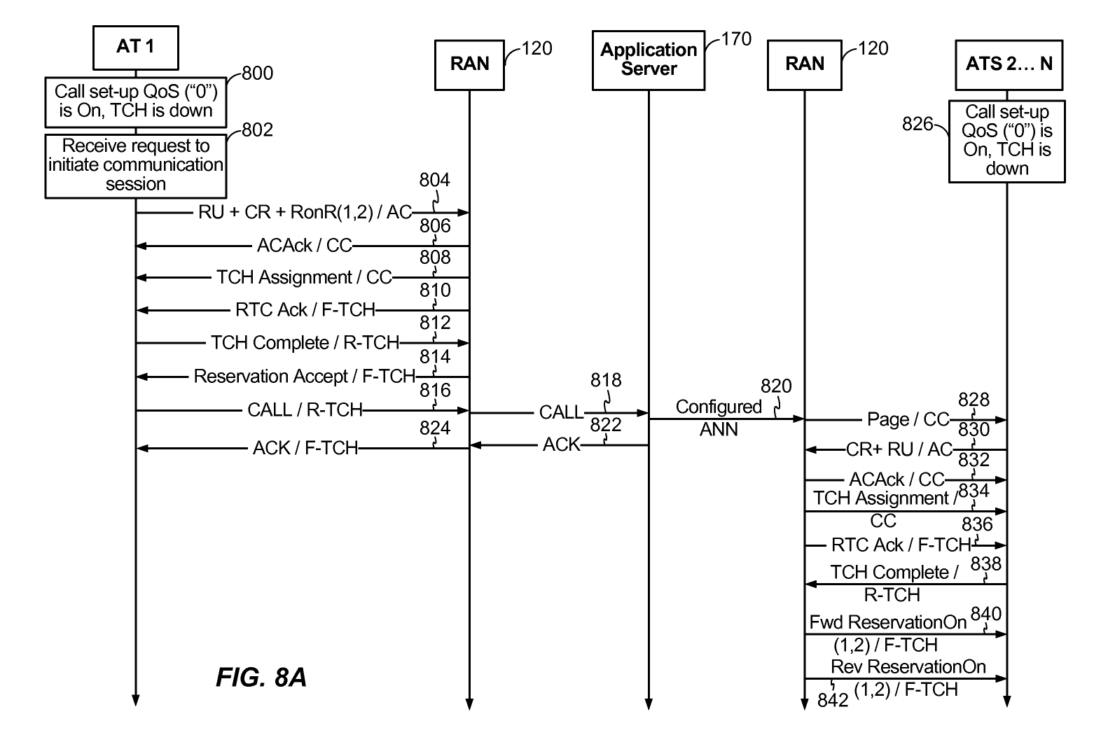

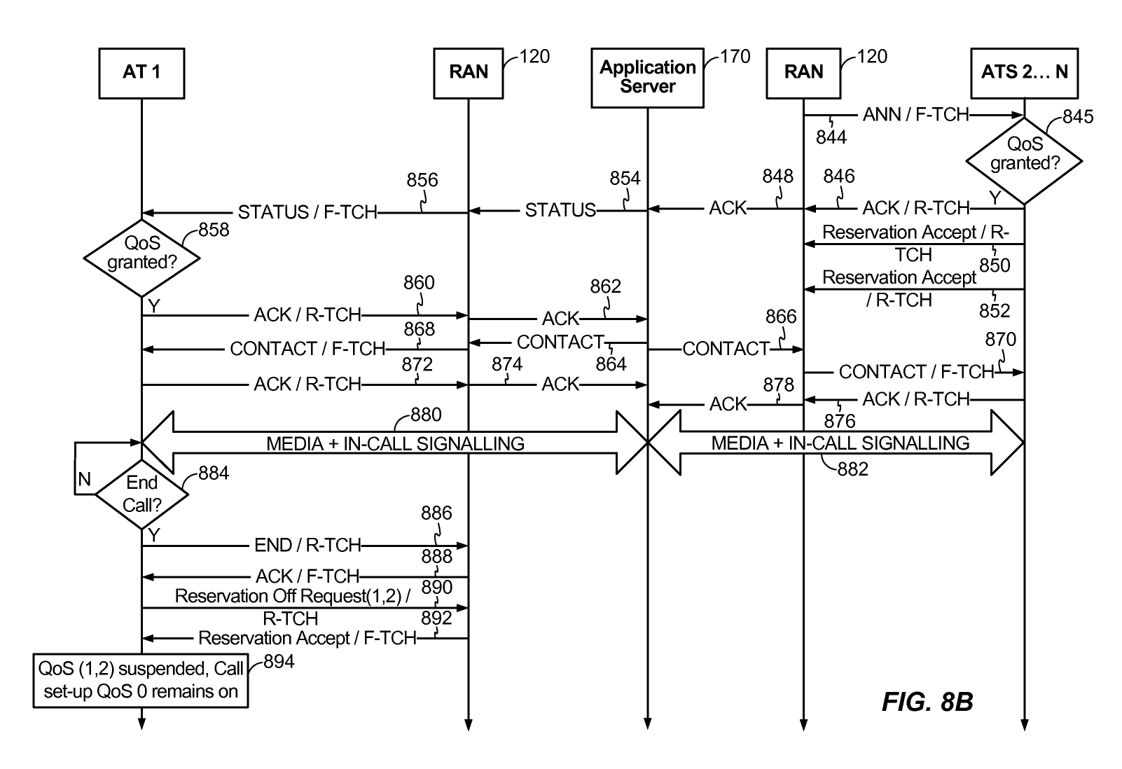

As discussed above, a communication session may include three IP flows at the AT, including a flow for Call-Setup Signaling, a flow for In-Call Signaling and a flow for Media. Each of these three IP flows may be associated with a given QoS resource reservation requirement. Conventionally, the QoS resource reservation for the Call-Setup Signaling flow is always turned on, whereas the QoS resource reservations for the In-Call Signaling and Media flows are only turned on when a communication session requiring the respective IP flows is active or being setup. By keeping the QoS resource reservation for the Call-Setup Signaling IP flow on at all times in a network that does not permit data to be sent over signaling channels (e.g., such as an EV-DO network that does not support data-over-signaling (DoS) or has DoS disabled in one or more sectors of the network), conventional call setup latency is potentially reduced because the call originator is guaranteed a certain amount of QoS resources during initial call setup signaling exchanges with the RAN 120. While embodiments of the invention are generally described below with respect to EV-DO terminology (e.g., access channel, forward traffic channel (F-TCH), RouteUpdate, ConnectionRequest, etc.), it will be appreciated that other embodiments can be directed to other air interfaces, such as W-CDMA. An example of a call setup process is described below with respect to FIGS. 8A and 8B.

Accordingly, FIGS. 8A and 8B illustrate a call setup process for a server-arbitrated communication session. Referring to FIG. 8A, in 800, assume that AT 1 is in a dormant state, such that AT 1 does not have an active traffic channel (TCH) and also does not have QoS resource reservations for media and in-call IP flows. However, AT 1's QoS resource reservation for its call setup IP flow is ‘on’ (e.g., currently allocated to AT 1 by the RAN 120, or reserved for AT 1 by the RAN 120). Again, a QoS resource reservation for the call setup IP flow for an AT is conventionally always ‘on’, even if the AT is in a dormant state.

Next, in 802, while AT 1 is in the dormant state, assume that a user of AT 1 requests initiation of a server-arbitrated communication session (e.g., a PTT session, a VoIP session, a group communication session, a half-duplex communication session, a full duplex communication session, etc.). For example, in the case of a PTT session, the triggering operation for 802 may correspond to the user of AT 1 pressing a PTT button on AT 1 to initiate a PTT communication session.

After the communication session request is received at AT 1, AT 1 sends a RouteUpdate message, a ConnectionRequest message and a ReservationOnRequest message on a reverse link access channel (AC) to the RAN 120, 804. The ReservationOnRequest message, or ROnR message, of 804 requests QoS resource reservations for IP flow 1 (i.e., the in-call IP flow) and IP flow 2 (i.e., the media IP flow), but not for IP flow 0 (i.e., the call setup IP flow) because the QoS resources for IP flow 0 are always reserved or allocated for AT 1, whereas QoS resource reservations for IP flows 1 and 2 are only turned on for AT 1 during communication sessions involving AT 1.

As will be appreciated, the messages transmitted in 804 are not necessarily bundled with a call message and/or included within a data over signaling (DoS) packet. The RAN 120 acknowledges receipt of the messages from 804 by sending an access channel acknowledgment (ACAck) on the downlink control channel to AT 1, 806. In 808, the RAN 120 sends TCH assignment to AT 1 on the downlink control channel in response to the ConnectionRequest message from 804, and the RAN 120 transmits a Reverse Traffic Channel Acknowledge (RTCAck) message, 810 on a forward traffic channel (F-TCH) allocated to AT 1 in the TCH Assignment message (e.g., after successfully receiving and decoding the DRC and pilot from AT 1, not shown in FIG. 8A). Upon receipt of the RTCAck message, AT 1 can send a Traffic Channel Complete (TCC) message, 812, on its newly allocated reverse traffic channel (R-TCH) to the RAN 120. The RAN 120 also sends a Reservation Accept message to AT 1 indicating that its requested QoS resource reservations for IP flow 1 (i.e., the in-call IP flow) and IP flow 2 (i.e., the media IP flow) have been reserved or allocated for AT 1, 814. As shown in 814, a single Reservation Accept message can be sent for multiple ‘unidirectional’ QoS flows (i.e., multiple reverse-link QoS flows, or multiple forward-link QoS flows). However, different Reservation Accept messages are required by EV-DO protocols to be sent for QoS flows in different directions. For example, reservation Accept is required per reservation grant message (like FwdReservationOn or RevReservation On message).

After obtaining the TCH, AT 1 sends at least one call message (e.g., at a given interval, such as every 500 ms, until a STATUS message is received from the RAN 120) on the R-TCH, 816, and the RAN 120 forwards the at least one call message to the application server 170, 818. The application server 170 forwards a ‘configured’ announce message (ANN) to the RAN 120 for transmission to ATs 2 . . . N, 820, and also acknowledges receipt of the at least one call message to the RAN 120, 822, which forwards a CALL-ACK message back to AT 1 on the F-TCH, 824. In 820, the ANN is configured to prompt the RAN 120 to preemptively allocate QoS resources to ATs 2 . . . N that respond to the page (in 828) without an explicit request for QoS resources from ATs 2 . . . N. This mechanism of preemptive QoS resource-allocation may be referred to as ‘predictive’ QoS. In an example, the application server 170 can insert a pre-defined bit-sequence into an IP-header of the ANN in 820 to trigger the RAN 120 to allocate the QoS resources (e.g., by sending FwdReservationOn and RevReservationOn messages at 840 and 842) to any page-responsive call targets among ATs 2 . . . N. In a further example, the pre-defined bit-sequence can correspond to a given DSCP value contained in the IP-header of the ANN.

Referring to FIG. 8A, in 826, assume that the call request is requesting initiation of a communication session to target ATs 2 . . . N (e.g., for a direct call or one-to-one call N=2, for a group communication session N>2), and that each of target ATs 2 . . . N are in a dormant state with no TCH and with QoS resources reserved for the call setup IP flow 0, but not for in-call IP flow 1 and/or media IP flow 2. Accordingly, upon receiving the announce message ANN from the application server 170, the RAN 120 pages each of ATs 2 . . . N by sending a page message on the downlink control channel, 828. Assume that each of ATs 2 . . . N responds to the page by sending ConnectionRequest and RouteUpdate messages on the reverse link access channel, 830. In an example, a request for QoS is not sent at this point from ATs 2 . . . N because the page-response is processed by a lower-level application configured to respond to pages automatically without necessarily notifying a higher-level multimedia application of receipt of the page for the higher-level multimedia application to determine whether to request QoS. In other words, pages arrive at ATs 2 . . . N for all sorts of reasons, and the pages are not necessarily related to the particular higher-level multimedia application that is managing the communication session associated with the announce message ANN. Thus, the lower-layer application does not necessarily notify the higher-level multimedia application of the page. However, because the ANN in 820 is configured to prompt a preemptive QoS resource-allocation by the RAN 120, an explicit request for QoS resources is not actually required to be sent by ATs 2 . . . N. The RAN 120 acknowledges the message from 830 by sending an ACAck message on the downlink control channel 832 to ATs 2 . . . N, and then assigns a TCH to ATs 2 . . . N by sending a TCH assignment message on the downlink control channel, 834. The RAN 120 transmits a Reverse Traffic Channel Acknowledge (RTCAck) message, 836, on a forward traffic channel (F-TCH) allocated to ATs 2 . . . N in the TCH Assignment message (e.g., after successfully receiving and decoding the DRC and pilot from ATs 2 . . . N, not shown in FIG. 8A).

Upon receipt of the RTCAck message, ATs 2 . . . N can send a Traffic Channel Complete (TCC) message, 838, on its newly allocated reverse traffic channel (R-TCH) to the RAN 120. Next, the RAN 120 sends FwdReservationOn and RevReservationOn messages to ATs 2 . . . N, 840 and 842, to allocate or reserve QoS resources for in-call IP flow 1 and media IP flow 2. In an example, the FwdReservationOn and RevReservationOn messages sent to ATs 2 . . . N in 840 and 842 can be triggered by the IP-header configuration of the ANN message in 820, instead of an explicit request for QoS resources (e.g., ReservationOnRequest messages) from ATs 2 . . . N. As will be appreciated, QoS resource reservations for call setup IP flow 0 are already allocated, and need not be allocated to ATs 2 . . . N at this point in the process of FIG. 8A.

Turning to FIG. 8B, the RAN 120 sends the announce message to ATs 2 . . . N on the F-TCH, 844. ATs 2 . . . N determine sufficient QoS resources have been granted to support the announced call in 845 and to accept the call announcement, and as such send announce ACK (accept) message(s) on the R-TCH to the RAN 120, 846, which then forwards the announce ACK (accept) message(s) to the application server 170, 848. ATs 2 . . . N also send Reservation Accept messages, 850 and 852, to accept and acknowledge receipt of the forward-link and reverse-link QoS reservations for IP flows 1 and 2. As shown in 850 and 852, different Reservation Accept messages are sent for QoS flows in different directions as allocated in 840 and 842 by the RAN 120, whereby 840 covers the forward-link QoS, and 842 covers the reverse-link QoS.

Upon receiving an announce ACK (accept) message from a first responder to the announced communication session, the application server 170 sends a STATUS message to the RAN 120 for transmission to AT 1, 854, and the RAN 120 transmits the STATUS message to AT 1 on the F-TCH, 856. Upon receiving the STATUS message, AT 1 determines whether QoS resource reservations have been allocated for each of AT 1's IP flows (e.g., IP flows 0, 1 and 2) related to the communication session, 858. In this case, it has already been established that the QoS resource reservations for each of IP flows 0, 1 and 2 are allocated to AT 1, and as such AT 1 determines to proceed with the call in 858. Accordingly, AT 1 acknowledges the STATUS message by sending a STATUS-ACK message to the RAN 120 on the R-TCH, 860, which then forwards the STATUS-ACK message to the application server 170, 862.

Upon receiving the STATUS-ACK message, the application server 170 sends a contact message to the RAN 120 for transmission to ATs 1 . . . N, 864 and 866. In an example, the contact message provides information regarding how ATs 1 . . . N can contact a media server at the application server 170 that will be handling the exchange of media between ATs 1 . . . N during the communication session. The RAN 120 transmits the contact message to AT 1 on AT 1's F-TCH, 868 and also to ATs 2 . . . N on their respective F-TCH(s), 870. Upon receipt of the contact message at AT 1, AT 1 sends a CONTACT-ACK to the RAN 120 on the R-TCH, 872, and the RAN 120 forwards the CONTACT-ACK from AT 1 to the application server 170, 874. Likewise, upon receipt of the contact message at ATs 2 . . . N, ATs 2 . . . N send a CONTACT-ACK to the RAN 120 on their respective R-TCH(s), 876, and the RAN 120 forwards the CONTACT-ACK(s) from ATs 2 . . . N to the application server 170, 878.

After receiving the contact information in the contact message, ATs 1 . . . N exchange media, through the application server 170, during the communication session, 880 and 882. As will be appreciated, AT 1 begins the communication session as floor-holder because AT 1 originated the call, but the floor-holder may change during the communication session based on signaling on the in-call IP flow. Likewise, media is transferred between ATs 1 . . . N using the media IP flow. QoS resource reservations for IP flows 1 and 2 are thereby ‘on’ for the duration of the communication session. QoS resource reservations for the IP flow 0, or the call setup IP flow, are also ‘on’ during the communication session, because these QoS resource reservations are assumed to be ‘always on’ for each of ATs 1 . . . N.

During the communication session, AT 1 periodically determines whether to end the communication session, 884. For example, AT 1 can determine to end the communication session due to TCH inactivity, or alternatively due to an explicit request by the user of AT 1 to end the communication session. If AT 1 determines not to end the communication session in 884, the process returns to 880 and the communication session continues. Otherwise, if AT 1 determines to end the communication session in 884, AT 1 sends an END message on the R-TCH to the RAN 120, 886, and the RAN 120 responds to the END message with an END-ACK message on the F-TCH, 888. AT 1 then releases the QoS resources reservations for IP flows 1 and 2 by sending a ReservationOffRequest message on the R-TCH to the RAN 120, 890, and the RAN 120 accepts the de-allocation or release of the QoS resource reservations for IP flows 1 and 2 by sending a Reservation Accept message on the F-TCH to AT 1, 892. At this point, in 894, AT 1 re-enters the dormant state from 800, such that QoS resource reservations for IP flows 1 and 2 are ‘off’ or suspended, while the QoS resource reservation for IP flow 0 (i.e., the call set-up IP flow) is maintained. While operations 884 through 894 are shown as occurring at AT 1, it will be appreciated that ATs 2 . . . N may also perform these operations. In other words, ATs 2 . . . N can, on their own, decide to exit the communication session as well. However, this potential decision logic occurring at ATs 2 . . . N has been omitted from FIG. 8B for convenience of explanation. Also, while not shown in FIG. 8B, after a given period of TCH-inactivity, a TCH-inactivity timer expires and the TCH will be torn down at ATs 1 . . . N.

As will be appreciated, maintaining QoS resource reservations for call setup IP flows at ATs 1 . . . N means that QoS resource reservations for the call setup IP flows need not be requested by and allocated to ATs 1 . . . N during the process of FIGS. 8A and 8B. This potentially saves time during the communication session setup process of FIGS. 8A and 8B (e.g., at least, in a network that either does not support DoS or has DoS disabled in one or more sectors). However, it will also be appreciated that maintaining the QoS resource reservations for call setup flows at ATs 1 . . . N reduces the capacity of the RAN 120 (e.g., where DoS is available). In the case where no active communication session involving ATs 1 . . . N is actually being executed, the reduced capacity may degrade system performance even though the call setup IP flows of ATs 1 . . . N that are associated with the above-noted QoS resource reservations are not actually being used.

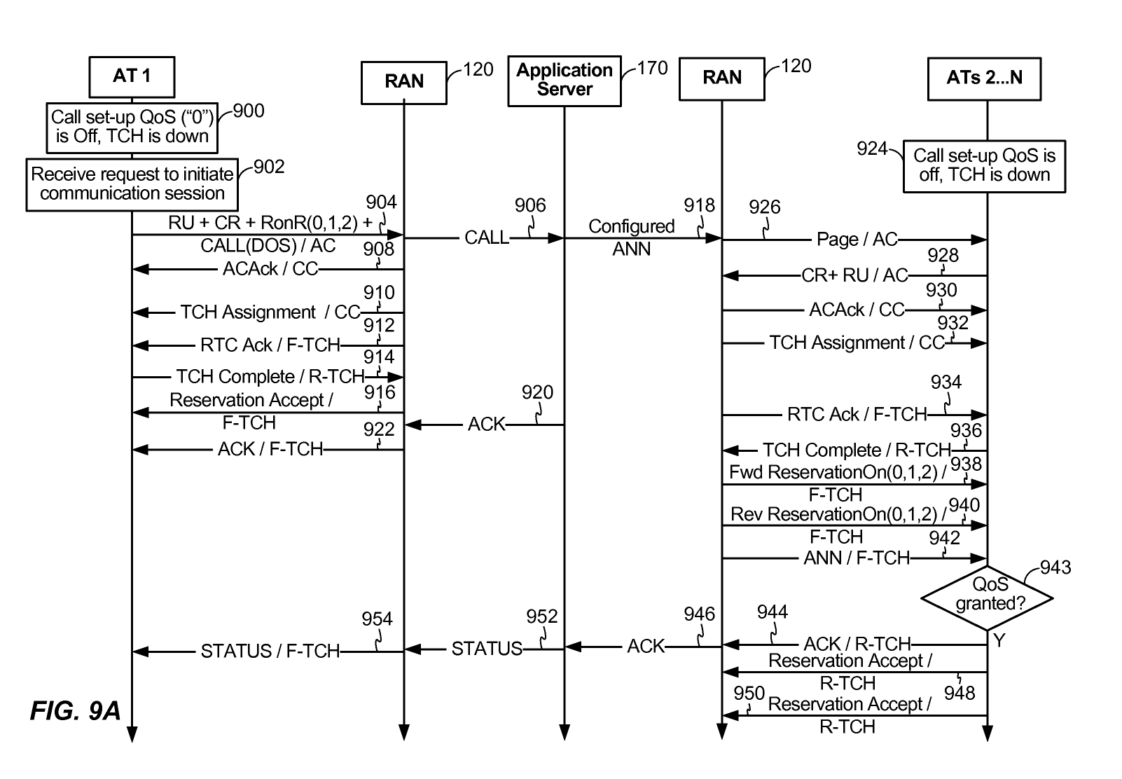

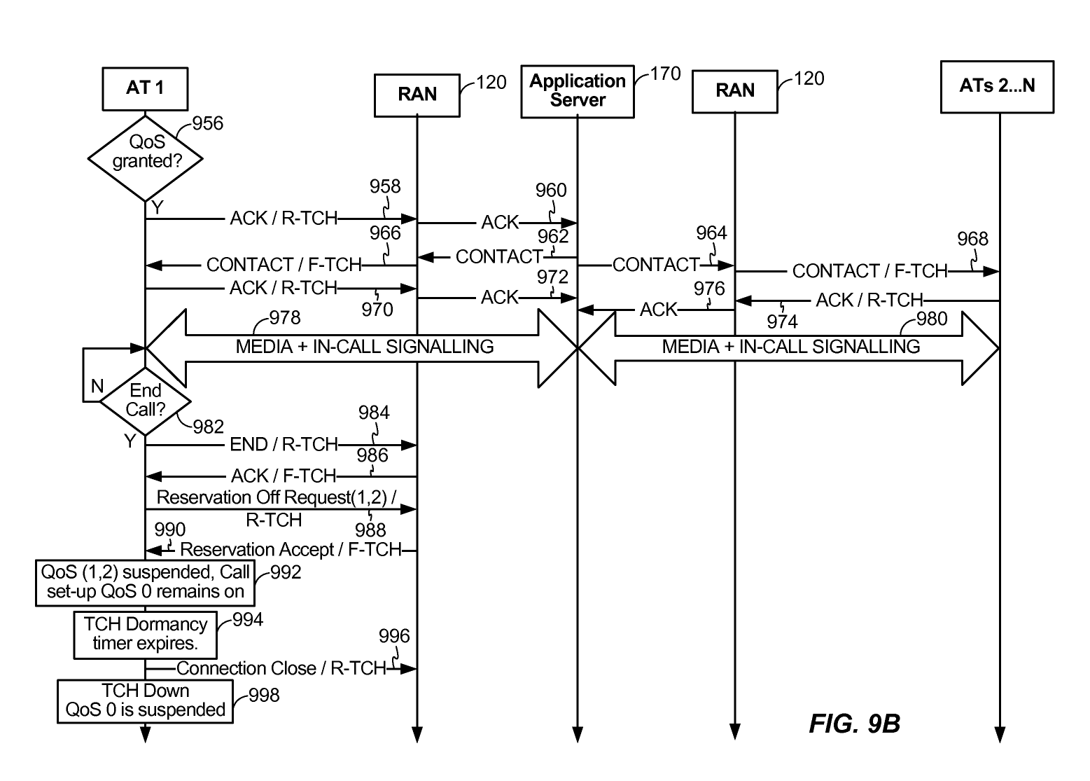

Accordingly, FIGS. 9A and 9B illustrate a call setup process for a server-arbitrated communication session in accordance with an embodiment of the invention, whereby a QoS resource reservation for a given AT's call setup IP flow is turned ‘on’ when a communication session is active or being setup, and is otherwise turned ‘off’.

Referring to FIG. 9A, in 900, assume that AT 1 is in a dormant state, such that AT 1 does not have an active traffic channel (TCH) and does not have QoS resources reserved for media and in-call IP flows. Further, unlike FIGS. 8A and 8B, in the dormant state of 900, AT 1 also does not have QoS resource reservations for its call setup IP flow. By contrast, the call setup IP flow is conventionally always ‘on’, even if an AT is in a dormant state, as shown in FIGS. 8A and 8B.

Next, in 902, while AT 1 is in the dormant state, assume that a user of AT 1 requests initiation of a server-arbitrated communication session (e.g., a PTT session, a group communication session, etc.). For example, in the case of a PTT session, the triggering operation for 902 may correspond to the user of AT 1 pressing a PTT button on AT 1 to initiate a PTT communication session.

After the communication session request is received at AT 1, AT 1 sends a bundled message including a RouteUpdate message, a ConnectionRequest message, a ReservationOnRequest message and a call message within a DoS packet on a reverse link access channel (AC) to the RAN 120, 904 (e.g., as in 320 of FIGS. 3A, 3B and/or 3C). The ReservationOnRequest message, or ROnR message, of 904 requests QoS resource reservations for IP flow 0 (i.e., the call setup IP flow), IP flow 1 (i.e., the in-call IP flow) and IP flow 2 (i.e., the media IP flow). By contrast, in 804 of FIG. 8A, the ReservationOnRequest message did not request QoS resource reservations related to the IP flow 0 (i.e., the call setup IP flow) because the QoS resource reservation for IP flow 0 was already turned on in FIG. 8A at this point. Also, the call message was not included in a DoS packet in FIG. 8A because bundling call messages within a DoS packet along with the RouteUpdate, ConnectionRequest and/or ReservationOnRequest messages is an embodiment of the invention.

Accordingly, in FIG. 9A, AT 1 sends the call message within the bundled message of 904 on the reverse link access channel, 904, and the RAN 120 forwards the call message to the application server 170, 906. The RAN 120 acknowledges receipt of the messages from 904 by sending an access channel acknowledgment (ACAck) on the downlink control channel to AT 1, 908, and sends a TCH assignment to AT 1 on the downlink control channel in response to the ConnectionRequest message from 904, 910.

In 912, the RAN 120 transmits a Reverse Traffic Channel Acknowledge (RTCAck) message on a forward traffic channel (F-TCH) allocated to AT 1 in the TCH Assignment message (e.g., after successfully receiving and decoding the DRC and pilot from AT 1, not shown in FIG. 9A). Upon receipt of the RTCAck message, AT 1 can send a Traffic Channel Complete (TCC) message, 914, on its newly allocated reverse traffic channel (R-TCH) to the RAN 120. The RAN 120 also sends a Reservation Accept message to AT 1 indicating that its requested QoS resource reservations for IP flow 0 (i.e., the call setup IP flow), IP flow 1 (i.e., the in-call IP flow) and IP flow 2 (i.e., the media IP flow) have been allocated for AT 1, 916.

Upon receiving the call message from the RAN 120 in 906, the application server 170 forwards an announce message (ANN) to the RAN 120 for transmission to ATs 2 . . . N, 918, and also acknowledges receipt of the call message to the RAN 120, 920, which transmits a CALL-ACK message back to AT 1 on the F-TCH, 922. As in 820 of FIG. 8A, the ANN is configured to prompt the RAN 120 to preemptively allocate QoS resources to ATs 2 . . . N that respond to the page (in 926) without an explicit request for QoS resources from ATs 2 . . . N. This mechanism of preemptive QoS resource-allocation may be referred to as ‘predictive’ QoS. In an example, the application server 170 can insert a pre-defined bit-sequence into an IP-header of the ANN in 918 to trigger the RAN 120 to allocate the QoS resources (e.g., by sending FwdReservationOn and RevReservationOn messages at 938 and 940) to any page-responsive call targets among ATs 2 . . . N. In a further example, the pre-defined bit-sequence can correspond to a given DSCP value contained in the IP-header of the ANN.

Referring to FIG. 9A, in 924, assume that the call request is requesting initiation of a communication session to target ATs 2 . . . N, and that each of target ATs 2 . . . N are in a dormant state with no TCH and with no QoS resources reserved for call setup IP flow 0, in-call IP flow 1 and/or media IP flow 2 (e.g., similar to AT 1's dormant state in 900).

Accordingly, upon receiving the announce message ANN from the application server 170, the RAN 120 pages each of ATs 2 . . . N by sending a page message on the downlink control channel, 926. Assume that each of ATs 2 . . . N responds to the page by sending ConnectionRequest and RouteUpdate messages on the reverse link access channel, 928. In an example, a request for QoS is not sent at this point from ATs 2 . . . N because the page-response is processed by a lower-level application configured to respond to pages automatically without necessarily notifying a higher-level multimedia application of receipt of the page for the higher-level multimedia application to determine whether to request QoS. In other words, pages arrive at ATs 2 . . . N for all sorts of reasons, and the pages are not necessarily related to the particular higher-level multimedia application that is managing the communication session associated with the announce message ANN. Thus, the lower-layer application does not necessarily notify the higher-level multimedia application of the page. For example, the higher-level multimedia application would be informed of the call upon receipt of the ANN message in 942, which occurs after ATs 2 . . . N acquire QoS resources (in 938 and 940) in the embodiment of FIG. 9A. In other words, because the ANN in 918 is configured to prompt a preemptive QoS resource-allocation by the RAN 120, an explicit request for QoS resources is not actually required to be sent by ATs 2 . . . N. The RAN 120 acknowledges the message from 928 by sending an ACAck message on the downlink control channel 930 to ATs 2 . . . N, and then assigns a TCH to ATs 2 . . . N by sending a TCH assignment message on the downlink control channel, 932. The RAN 120 transmits a Reverse Traffic Channel Acknowledge (RTCAck) message, 934, on a forward traffic channel (F-TCH) allocated to ATs 2 . . . N in the TCH Assignment message (e.g., after successfully receiving and decoding the DRC and pilot from ATs 2 . . . N, not shown in FIG. 9A).

Upon receipt of the RTCAck message, ATs 2 . . . N can send a Traffic Channel Complete (TCC) message, 936, on their newly allocated reverse traffic channel(s) (R-TCH) to the RAN 120. Next, the RAN 120 sends FwdReservationOn and RevReservationOn messages to ATs 2 . . . N, 938 and 940, to allocate QoS resource reservations for the call setup IP flow 0, in-call IP flow 1 and media IP flow 2. In an example, the FwdReservationOn and RevReservationOn messages sent to ATs 2 . . . N in 938 and 940 can be triggered by the IP-header configuration of the ANN message in 918, instead of an explicit request for QoS resources (e.g., ReservationOnRequest messages) from ATs 2 . . . N. As will be appreciated, unlike FIGS. 8A and 8B, QoS resource reservations for call setup IP flow 0 are allocated to ATs 2 . . . N in 938 and 940.

The RAN 120 sends the announce (ANN) message to ATs 2 . . . N on the F-TCH, 942. ATs 2 . . . N determine sufficient QoS resources have been granted to support the announced call in 943 and to accept the call announcement, and as such send announce ACK (accept) message(s) on the R-TCH to the RAN 120, 944, which then forwards the announce ACK (accept) message(s) to the application server 170, 946. ATs 2 . . . N also send Reservation Accept messages, 948 and 950, to accept and acknowledge receipt of the forward-link and reverse-link QoS resource reservations for IP flows 0, 1 and 2. As shown in 948 and 950, different Reservation Accept messages are sent for QoS flows in different directions as allocated in 938 and 940 by the RAN 120, whereby 938 covers the forward-link QoS, and 940 covers the reverse-link QoS.

Upon receiving an announce ACK (accept) message from a first responder to the announced communication session, the application server 170 sends a STATUS message to the RAN 120 for transmission to AT 1, 952, and the RAN 120 transmits the STATUS message to AT 1 on the F-TCH, 954. Turning to FIG. 9B, upon receiving the STATUS message, AT 1 determines whether QoS resource reservations have been allocated for the communication session, 956. In this case, it has already been established that the QoS resource reservations for each of IP flows 0, 1 and 2 are allocated to AT 1, and as such AT 1 determines to proceed with the call in 956. Accordingly, AT 1 acknowledges the STATUS message by sending a STATUS-ACK message to the RAN 120 on the R-TCH, 958, which then forwards the STATUS-ACK message to the application server 170, 960.

Upon receiving the STATUS-ACK message, the application server 170 sends a contact message to the RAN 120 for transmission to ATs 1 . . . N, 962 and 964. In an example, the contact message provides information regarding how ATs 1 . . . N can contact a media server at the application server 170 that will be handling the exchange of media between ATs 1 . . . N during the communication session. The RAN 120 transmits the contact message to AT 1 on AT 1's F-TCH, 966, and also to ATs 2 . . . N on their respective F-TCH(s), 968. Upon receipt of the contact message at AT 1, AT 1 sends a CONTACT-ACK to the RAN 120 on the R-TCH, 970, and the RAN 120 forwards the CONTACT-ACK from AT 1 to the application server 170, 972. Likewise, upon receipt of the contact message, ATs 2 . . . N send a CONTACT-ACK to the RAN 120 on their respective R-TCH(s), 974, and the RAN 120 forwards the CONTACT-ACK(s) from ATs 2 . . . N to the application server 170, 976.

After receiving the contact information in the contact message, ATs 1 . . . N exchange media, through the application server 170, during the communication session, 978 and 980. As will be appreciated, AT 1 begins the communication session as floor-holder because AT 1 originated the call, but the floor-holder may change during the communication session based on signaling on the in-call IP flow. Likewise, media is transferred between ATs 1 . . . N using the media IP flow, and signaling related to the initial call setup of the communication session uses the call setup IP flow. QoS resource reservations for each IP flow are thereby ‘on’ for the duration of the communication session.

During the communication session, AT 1 periodically determines whether to end the communication session, 982. For example, AT 1 can determine to end the communication session due to TCH inactivity, or alternatively due to an explicit request by the user of AT 1 to end the communication session. If AT 1 determines not to end the communication session in 982, the process returns to 978 and the communication session continues. Otherwise, if AT 1 determines to end the communication session in 982, AT 1 sends an END message on the R-TCH to the RAN 120, 984, and the RAN 120 responds to the END message with an END-ACK message on the F-TCH, 986. AT 1 then releases the QoS resources reservations for IP flows 1 and 2 by sending a ReservationOffRequest message on the R-TCH to the RAN 120, 988, and the RAN 120 accepts the de-allocation or release of the QoS resource reservations for IP flows 1 and 2 by sending a Reservation Accept message on the F-TCH to AT 1, 990. At this point, in 992, AT 1's QoS resource reservations for IP flows 1 and 2 are ‘off’ or suspended, while the QoS resource reservation for IP flow 0 (i.e., the call set-up IP flow) is maintained.

At some point after 992, assume that AT 1 is inactive for a period of time exceeding an expiration for a TCH-dormancy timer (or TCH-inactivity timer), such that the TCH-dormancy timer expires, 994. The expiration of the TCH-dormancy timer triggers AT 1 to tear-down its TCH by sending a Connection Close message on the R-TCH to the RAN 120, 996. At this point, the TCH at AT 1 is down and the QoS resource reservation(s) for IP flow 0 are ‘off’ or suspended, 998. In an example, as shown in FIG. 9B, the Connection Close message from AT 1 can function as an implicit ReservationOffRequest for IP Flow 0 such that an explicit ReservationOffRequest for IP Flow 0 need not be sent. In another embodiment, while not shown in FIGS. 9A and 9B, AT 1 can send an explicit ReservationOffRequest for IP Flow 0 in addition to the Connection Close message of 996 to turn off the QoS resource reservation(s) for IP Flow 0.

In an alternative embodiment, it is possible that the TCH-dormancy timer can expire before the END message is sent in 984. In this case, the Connection Close message of 996 can be triggered upon expiration of the TCH-dormancy timer at this earlier point in the call flow. As will be appreciated, the Connection Close message in this alternative embodiment can be configured to function as an implicit ReservationOffRequest for each of IP Flows 0, 1 and 2 such that explicit ReservationOffRequest messages for IP Flows 0, 1 and 2 need not be sent. In another embodiment, while not shown in FIGS. 9A and 9B, AT 1 can send explicit ReservationOffRequest messages for IP Flows 0, 1 and 2 in addition to the ‘early’ Connection Close message to turn off the QoS resource reservation(s) for IP Flows 0, 1 and 2 in this alternative embodiment.

While operations 982 through 998 are shown as occurring at AT 1, it will be appreciated that ATs 2 . . . N may also perform these operations. In other words, ATs 2 . . . N can, on their own, decide to exit the communication session as well. However, this potential decision logic occurring at ATs 2 . . . N has been omitted from FIG. 9B for convenience of explanation.

Further, in the embodiments of the invention described above, the QoS-evaluations performed at the respective ATs (e.g., at 845 and/or 858 of FIG. 8B, 943 and/or 956 of FIG. 9B, etc.) are described as if QoS is a binary variable (i.e., QoS ‘ON’ or QoS ‘OFF’). However, in other embodiments of the invention, different degrees of levels of QoS can be evaluated at a given AT and/or the RAN 120. For example, in a binary-type implementation, as described above, QoS levels can be negotiated and assigned at the time of powering up the group communication session management application (e.g., QChat client). Current implementations of W-CDMA correspond to the binary-type implementation in the sense that only one QoS flow is used, and this QoS flow is either ON or OFF.

Alternatively, the given AT can request more than one QoS flow, and the RAN 120 may grant only a partial number of flows. In this sense, the requested QoS may be only made ‘partially’ available to the given AT in an example. For example, the RAN 120 may grant QoS flows in the forward direction and reject flows in the reverse direction. Based on such an allocation, the given AT may decide to ACK (accept) the STATUS and later re-request the flows in the reverse direction. In other words, the decision blocks of 845 and/or 858 of FIG. 8B or 943 and/or 956 of FIG. 9B can evaluate whether a sufficient level of QoS resources have been obtained (e.g., forward link QoS flow where reverse link QoS flow is less important for a half-duplex call target, reverse link QoS flow where forward link QoS flow is less important for a half-duplex call originator or floor-holder, etc.), instead of whether all requested QoS has been obtained. Currently implementations of EV-DO deploy multiple QoS flows, with the QoS flow considered to be OFF if any of the multiple flows are not available or turned on by the RAN 120.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Accordingly, an embodiment of the invention can include a computer-readable medium including code stored thereon for bundling communication messages in a wireless network comprising: code for causing a computer to bundle a connection request and a reservation for QoS resources into an access message, and code for causing a computer to transmit the access message to an access network. Further, any of the functions describe herein can be included in as additional code in further embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of obtaining Quality of Service (QoS) resource reservations during a communication session within a wireless communications system, comprising:
receiving, at an originating access terminal in a dormant state, a request to initiate a communication session with at least one target access terminal, the dormant state of the originating access terminal characterized by (i) the originating access terminal not having an active traffic channel (TCH) associated with the communication session to be initiated and (ii) the originating access terminal not having a QoS resource reservation at least for an Internet Protocol (IP) flow associated with call setup for the communication session to be initiated;
configuring a message at least to request the QoS resource reservation for the IP flow associated with call setup for the communication session to be initiated; and
transmitting the configured message to an access network.

2. The method of claim 1, wherein the configured message corresponds to a bundled message that includes two or more of (i) the request for the QoS resource reservation for the IP flow associated with call setup for the communication session to be initiated, (iii) a request for the active TCH, (iii) a request for a QoS resource reservation for an IP flow associated with in-call signaling for the communication session to be initiated, (iv) a request for a QoS resource reservation for an IP flow associated with media for the communication session to be initiated, (v) a call request message and (vi) a location-update message.

3. The method of claim 2, further comprising:
receiving, from the access network in response to the bundled message, an assignment of the requested TCH and indications of acceptance for the IP flows associated with each of call set-up, in-call signaling and media for the communication session to be initiated.

4. The method of claim 1,
wherein the configured message is a data-over-signaling (DoS) packet, and
wherein the transmitting step transmits the configured message over a signaling channel.

5. The method of claim 1, further comprising:
receiving an indication that the access network has accepted the request of the QoS resource reservation for the IP flow associated with call setup for the communication session to be initiated.

6. A method of provisioning Quality of Service (QoS) resource reservations during a server-arbitrated communication session within a wireless communications system, comprising:
receiving, at an access network, a first message in association with a request to initiate a communication session between an originating access terminal and at least one target access terminal, the first message configured at least to request a QoS resource reservation for an Internet Protocol (IP) flow associated with call setup for the communication session to be initiated; and
transmitting, in response to the first message, a second message indicating at least that the request by the originating access terminal for the QoS resource reservations for the IP flow associated with call setup for the communication session to be initiated has been accepted by the access network.

7. The method of claim 6, wherein the first message corresponds to a bundled message that includes two or more of (i) the request for the QoS resource reservation for the IP flow associated with call setup for the communication session to be initiated, (iii) a request for a traffic channel (TCH), (iii) a request for a QoS resource reservation for an IP flow associated with in-call signaling for the communication session to be initiated, (iv) a request for a QoS resource reservation for an IP flow associated with media for the communication session to be initiated, (v) a call request message and (vi) a location-update message.

8. The method of claim 7, further comprising:
transmitting, from the access network in response to the bundled message, an assignment of the requested TCH and indications of acceptance for the IP flows associated with each of call set-up, in-call signaling and media for the communication session to be initiated.

9. The method of claim 7, further comprising:
forwarding the call request message to an application server that is configured to arbitrated the communication session to be initiated.

10. The method of claim 6, wherein the first message is included within a data-over-signaling (DoS) packet and is received on a signaling channel.

11. The method of claim 6, further comprising:
transmitting an indication that the access network has accepted the request of the QoS resource reservation for the IP flow associated with call setup for the communication session to be initiated.

12. A method of provisioning Quality of Service (QoS) resource reservations during a server-arbitrated communication session within a wireless communications system, comprising:
transmitting, during setup of a communication session between an originating access terminal and at least one target access terminal, a traffic channel assignment message that assigns a traffic channel to the at least one target access terminal; and
transmitting, on the forward link of the assigned traffic channel, a QoS resource reservation assignment message to the at least one target access terminal, the QoS resource reservation assignment message indicating at least that a QoS resource reservation for an Internet Protocol (IP) flow associated with call setup for the communication session has been allocated to the at least one target access terminal.

13. The method of claim 12, further comprising:
receiving an announce message from an application server that is configured to arbitrate the communication session;
determining that the announce message is configured to prompt preemptive allocation of QoS resources to the at least one target access terminal,
wherein the transmitting of the QoS resource reservation assignment message is triggered responsive to the determination without an explicit request for QoS resources being received from the at least one target access terminal.

14. The method of claim 12, wherein the QoS resource reservation assignment message is further configured to indicate that QoS resource reservations for IP flows associated with in-call signaling and media for the communication session have also been allocated to the at least one target access terminal.

15. The method of claim 12, further comprising:
receiving an indication that the at least one target access terminal has accepted the request of the QoS resource reservation for the IP flow associated with call setup for the communication session.

16. A method of provisioning Quality of Service (QoS) resource reservations during a server-arbitrated communication session within a wireless communications system, comprising:
receiving, during setup of a communication session between an originating access terminal and at least one target access terminal, a traffic channel assignment message that assigns a traffic channel to a given target access terminal of the communication session;
receiving, on the forward link of the assigned traffic channel, a QoS resource reservation assignment message at the given target access terminal, the QoS resource reservation assignment message indicating at least that a QoS resource reservation for an Internet Protocol (IP) flow associated with call setup for the communication session has been allocated to the given target access terminal; and
transmitting at least one message to an access network indicating that the allocated QoS resource reservation for the IP flow associated with call setup for the communication session to be initiated has been accepted by the given target access terminal.

17. The method of claim 16, wherein the QoS resource reservation assignment message is received without an explicit request for QoS resources being received from the given target access terminal.

18. The method of claim 16, wherein the QoS resource reservation assignment message is further configured to indicate that QoS resource reservations for IP flows associated with in-call signaling and media for the communication session have also been allocated to the at least one target access terminal.

19. An access terminal configured to obtain Quality of Service (QoS) resource reservations during a communication session within a wireless communications system, comprising:
means for receiving, while the access terminal is in a dormant state, a request to initiate a communication session with at least one target access terminal, the dormant state of the access terminal characterized by (i) the access terminal not having an active traffic channel (TCH) associated with the communication session to be initiated and (ii) the access terminal not having a QoS resource reservation at least for an Internet Protocol (IP) flow associated with call setup for the communication session to be initiated;
means for configuring a message at least to request the QoS resource reservation for the IP flow associated with call setup for the communication session to be initiated; and
means for transmitting the configured message to an access network.

20. An access network configured to provision Quality of Service (QoS) resource reservations during a server-arbitrated communication session within a wireless communications system, comprising:
means for receiving a first message in association with a request to initiate a communication session between an originating access terminal and at least one target access terminal, the first message configured at least to request a QoS resource reservation for an Internet Protocol (IP) flow associated with call setup for the communication session to be initiated; and
means for transmitting, in response to the first message, a second message indicating at least that the request by the originating access terminal for the QoS resource reservations for the IP flow associated with call setup for the communication session to be initiated has been accepted by the access network.

21. An access network configured to provision Quality of Service (QoS) resource reservations during a server-arbitrated communication session within a wireless communications system, comprising:
means for transmitting, during setup of a communication session between an originating access terminal and at least one target access terminal, a traffic channel assignment message that assigns a traffic channel to the at least one target access terminal; and
means for transmitting, on the forward link of the assigned traffic channel, a QoS resource reservation assignment message to the at least one target access terminal, the QoS resource reservation assignment message indicating at least that a QoS resource reservation for an Internet Protocol (IP) flow associated with call setup for the communication session has been allocated to the at least one target access terminal.

22. An access terminal configured to obtain Quality of Service (QoS) resource reservations during a communication session within a wireless communications system, comprising:
means for receiving, during setup of a communication session between an originating access terminal and at least one target access terminal, a traffic channel assignment message that assigns a traffic channel to a given target access terminal of the communication session;
means for receiving, on the forward link of the assigned traffic channel, a QoS resource reservation assignment message at the given target access terminal, the QoS resource reservation assignment message indicating at least that a QoS resource reservation for an Internet Protocol (IP) flow associated with call setup for the communication session has been allocated to the given target access terminal; and
means for transmitting at least one message to an access network indicating that the allocated QoS resource reservation for the IP flow associated with call setup for the communication session to be initiated has been accepted by the given target access terminal.

23. An access terminal configured to obtain Quality of Service (QoS) resource reservations during a communication session within a wireless communications system, comprising:
logic configured to receive, while the access terminal is in a dormant state, a request to initiate a communication session with at least one target access terminal, the dormant state of the access terminal characterized by (i) the access terminal not having an active traffic channel (TCH) associated with the communication session to be initiated and (ii) the access terminal not having a QoS resource reservation at least for an Internet Protocol (IP) flow associated with call setup for the communication session to be initiated;
logic configured to configure a message at least to request the QoS resource reservation for the IP flow associated with call setup for the communication session to be initiated; and
logic configured to transmit the configured message to an access network.

24. An access network configured to provision Quality of Service (QoS) resource reservations during a server-arbitrated communication session within a wireless communications system, comprising:
logic configured to receive a first message in association with a request to initiate a communication session between an originating access terminal and at least one target access terminal, the first message configured at least to request a QoS resource reservation for an Internet Protocol (IP) flow associated with call setup for the communication session to be initiated; and
logic configured to transmit, in response to the first message, a second message indicating at least that the request by the originating access terminal for the QoS resource reservations for the IP flow associated with call setup for the communication session to be initiated has been accepted by the access network.

25. An access network configured to provision Quality of Service (QoS) resource reservations during a server-arbitrated communication session within a wireless communications system, comprising:
logic configured to transmit, during setup of a communication session between an originating access terminal and at least one target access terminal, a traffic channel assignment message that assigns a traffic channel to the at least one target access terminal; and
logic configured to transmit, on the forward link of the assigned traffic channel, a QoS resource reservation assignment message to the at least one target access terminal, the QoS resource reservation assignment message indicating at least that a QoS resource reservation for an Internet Protocol (IP) flow associated with call setup for the communication session has been allocated to the at least one target access terminal.

26. An access terminal configured to obtain Quality of Service (QoS) resource reservations during a communication session within a wireless communications system, comprising:
logic configured to receive, during setup of a communication session between an originating access terminal and at least one target access terminal, a traffic channel assignment message that assigns a traffic channel to a given target access terminal of the communication session;
logic configured to receive, on the forward link of the assigned traffic channel, a QoS resource reservation assignment message at the given target access terminal, the QoS resource reservation assignment message indicating at least that a QoS resource reservation for an Internet Protocol (IP) flow associated with call setup for the communication session has been allocated to the given target access terminal; and
logic configured to transmit at least one message to an access network indicating that the allocated QoS resource reservation for the IP flow associated with call setup for the communication session to be initiated has been accepted by the given target access terminal.

27. A non-transitory computer-readable storage medium containing instructions, which, when executed by an access terminal configured to obtain Quality of Service (QoS) resource reservations during a communication session within a wireless communications system, cause the access terminal to perform operations, the instructions comprising:
program code to receive, while the access terminal is in a dormant state, a request to initiate a communication session with at least one target access terminal, the dormant state of the access terminal characterized by (i) the access terminal not having an active traffic channel (TCH) associated with the communication session to be initiated and (ii) the access terminal not having a QoS resource reservation at least for an Internet Protocol (IP) flow associated with call setup for the communication session to be initiated;
program code to configure a message at least to request the QoS resource reservation for the IP flow associated with call setup for the communication session to be initiated; and
program code to transmit the configured message to an access network.

28. A non-transitory computer-readable storage medium containing instructions, which, when executed by an access network configured to provision Quality of Service (QoS) resource reservations during a communication session within a wireless communications system, cause the access network to perform operations, the instructions comprising:
program code to receive a first message in association with a request to initiate a communication session between an originating access terminal and at least one target access terminal, the first message configured at least to request a QoS resource reservation for an Internet Protocol (IP) flow associated with call setup for the communication session to be initiated; and
program code to transmit, in response to the first message, a second message indicating at least that the request by the originating access terminal for the QoS resource reservations for the IP flow associated with call setup for the communication session to be initiated has been accepted by the access network.

29. A non-transitory computer-readable storage medium containing instructions, which, when executed by an access network configured to provision Quality of Service (QoS) resource reservations during a communication session within a wireless communications system, cause the access network to perform operations, the instructions comprising:
program code to transmit, during setup of a communication session between an originating access terminal and at least one target access terminal, a traffic channel assignment message that assigns a traffic channel to the at least one target access terminal; and
program code to transmit, on the forward link of the assigned traffic channel, a QoS resource reservation assignment message to the at least one target access terminal, the QoS resource reservation assignment message indicating at least that a QoS resource reservation for an Internet Protocol (IP) flow associated with call setup for the communication session has been allocated to the at least one target access terminal.

30. A non-transitory computer-readable storage medium containing instructions, which, when executed by an access terminal configured to obtain Quality of Service (QoS) resource reservations during a communication session within a wireless communications system, cause the access terminal to perform operations, the instructions comprising:
program code to receive, during setup of a communication session between an originating access terminal and at least one target access terminal, a traffic channel assignment message that assigns a traffic channel to a given target access terminal of the communication session;
program code to receive, on the forward link of the assigned traffic channel, a QoS resource reservation assignment message at the given target access terminal, the QoS resource reservation assignment message indicating at least that a QoS resource reservation for an Internet Protocol (IP) flow associated with call setup for the communication session has been allocated to the given target access terminal; and
program code to transmit at least one message to an access network indicating that the allocated QoS resource reservation for the IP flow associated with call setup for the communication session to be initiated has been accepted by the given target access terminal.
